(19) United States
(12) Patent Application Publication
(10) Pub. No.: US 2022/0048468 A1
(43) Pub. Date: Feb. 17, 2022

(54) SYSTEMS AND METHODS FOR VEHICLE INVENTORY MANAGEMENT

(71) Applicants: William M. Bucheleres, Littleton, CO (US); Gena Grace Tennyson, Littleton, CO (US)

(72) Inventors: William M. Bucheleres, Littleton, CO (US); Gena Grace Tennyson, Littleton, CO (US)

(21) Appl. No.: 17/400,451

(22) Filed: Aug. 12, 2021

Related U.S. Application Data
(60) Provisional application No. 63/065,062, filed on Aug. 13, 2020.

(51) Int. Cl. B60R 25/24; B60R 25/102

(52) U.S. Cl. CPC B60R 25/24; B60R 2325/205; B60R 25/102

(57) ABSTRACT

Implementations described and claimed provide systems and methods for vehicle inventory management. In one implementation, a security triggering event corresponding to a security of a vehicle inventory fleet is identified. The vehicle inventory fleet includes a plurality of vehicles. A security command is sent to all of the plurality of vehicles over a network in response to the security triggering event. The security command causes all of the plurality of vehicles to lock. A confirmation that the vehicle inventory fleet is secure is received after all of the plurality of vehicles are locked.

### CROSS-REFERENCE TO RELATED APPLICATIONS

The present application claims priority under 35 U.S.C. § 119 to U.S. Provisional Application No. 63/065,062, entitled “Systems and Methods For Vehicle Inventory Management” and filed on Aug. 13, 2020, which is specifically incorporated by reference herein in its entirety.

### TECHNICAL FIELD

Aspects of the present disclosure relate to systems and methods for vehicle inventory management, and in particular to managing a fleet of inventory vehicles, including locking and unlocking the fleet.

### BACKGROUND

Dealerships and other companies managing a fleet of vehicles for sale, lease, or rent are challenged with ensuring that each of the numerous vehicles in the fleet is secured to prevent theft, particularly outside business hours. Conventionally, such companies will pay a person to walk through the lot, manually locking each vehicle in the fleet. Manually locking the vehicles in this manner is inefficient and prone to human error.

Additionally, tracking a status of each of the vehicles is difficult and time consuming. For example, dealerships often employ multiple sales personnel that are showing different vehicles from an inventory fleet to various customers. A vehicle may be low on gas following a test drive with a first salesperson, and before the first salesperson can have the tank filled, another salesperson may be showing the vehicle to another customer. Here, the second salesperson would have to make the customer wait while the tank is filled with gas, which can be a frustrating experience for the customer. Timely addressing vehicle conditions, such as low fuel, dead batteries, and/or the like, that occur at different times across a fleet of numerous vehicles is burdensome and often impractical and can significantly impact the customer experience.

It is with these observations in mind, among others, that various aspects of the present disclosure were conceived and developed.

### SUMMARY

Implementations described and claimed herein address the foregoing problems by providing systems and methods for vehicle inventory management. In one implementation, a security triggering event corresponding to a security of a vehicle inventory fleet is identified. The vehicle inventory fleet includes a plurality of vehicles. A security command is sent to all of the plurality of vehicles over a network in response to the security triggering event. The security command causes all of the plurality of vehicles to lock. A confirmation that the vehicle inventory fleet is secure is received after all of the plurality of vehicles are locked.

In another implementation, an inventory management command is received at a vehicle inventory controller associated with a particular vehicle. The inventory management command is sent in response to an inventory triggering event for a vehicle inventory subset. The vehicle inventory subset includes one or more vehicles selected from a vehicle inventory fleet. The vehicle inventory subset includes the particular vehicle. The inventory management command includes one of a locking command or an unlocking command. The inventory management command is converted to a vehicle specific command for the particular vehicle using the vehicle inventory controller. The vehicle specific command is communicated to a locking subsystem of the particular vehicle. The vehicle specific command is executed using the locking subsystem to unlock or lock the particular vehicle.

In yet another implementation, inventory management data for a dealership is received from an inventory management controller. The inventory management data corresponds to a vehicle inventory fleet including a plurality of vehicles. Fleet locking status data for the vehicle inventory fleet during a specified time period over a compliance period is extracted from the inventory management data. Compliance analytics for the dealership for the compliance period is generated using the fleet locking status data.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system for vehicle inventory management.

FIG. 2 depicts an example network environment, including an inventory manager running on a server or other computing device coupled with a network, for providing vehicle inventory management.

FIG. 3 illustrates example operations for vehicle inventory management.

FIG. 4 shows example operations for managing a vehicle in a vehicle inventory fleet.

FIG. 5 depicts example operations for vehicle inventory management compliance.

FIG. 6 illustrates an example vehicle inventory management user interface executed by the inventory manager and displayed on a display of a user interface.

FIG. 7 shows an example computing system that may implement various systems and methods discussed herein.

### DETAILED DESCRIPTION

Aspects of the present disclosure involve systems and methods for vehicle inventory management. In one aspect, an inventory management controller communicates with one or more user devices and a fleet of vehicles over a network to provide a single central mechanism for locking and unlocking an entirety of the fleet of vehicles simultaneously. The inventory management controller further extracts onboard diagnostic data from each of the vehicles in the fleet and generates alerts based on the onboard diagnostic data that are presented in a unified interface. Additionally, inventory management data may be obtained from the inventory management controller to determine compliance with security requirements for the fleet of vehicles.

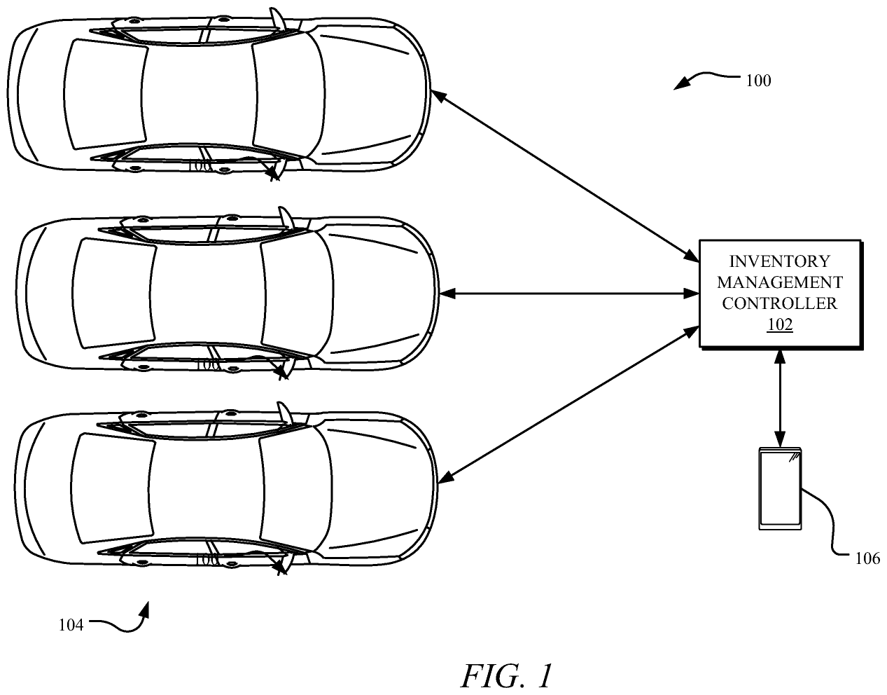

To begin a detailed description of an example vehicle inventory management system 100, reference is made to FIG. 1. In one implementation, a fleet manager, such as a dealership, a rental car agency, a new or used car retailer, a long-haul trailer manager, and/or another company managing a fleet of vehicles for sale, lease, rent, or use, owns or otherwise manages a vehicle inventory fleet 104 including a plurality of vehicles. While the various examples described herein reference a dealership having an inventory of new or used passenger vehicles, such as cars and trucks, it will be appreciated that such references are for illustrative purposes only and the presently disclosed technology is applicable to other types of fleet managers and vehicle inventories.

In one implementation, one or more user devices 106 communicates with the inventory management controller 102 to manage the vehicle inventory fleet 104. The user device 106 may be separate from or integrated with the inventory management controller 102. The user device 106 and/or the inventory management controller 102 may be: a control panel deployed in the dealership, an administrative office, or other central location; a mobile device, such as a smartphone, a tablet, or a personal computer; and/or other forms of computing devices with one or more input and/or output devices through which the user may interact with the inventory management controller 102. For example, the inventory management controller 102 may be a computing device disposed at the dealership and configured to communicate with the user device 106 and the vehicle inventory fleet 104.

The inventory management controller 102 may communicate with each vehicle in the vehicle inventory fleet 104 directly or indirectly. More particularly, each of the vehicles may have an associated vehicle inventory controller that communicates with the inventory management controller 102. Each of the vehicle inventory controllers may be a separate, removable computing device deployed into the corresponding vehicles. Here, the vehicle inventory controller communicates with a vehicle controller of the corresponding vehicle. In another implementation, the vehicle inventory controller is integrated with the vehicle controller, such that the inventory management controller 102 communicates directly with the vehicle. In some implementations, the vehicle inventory fleet 104 has a plurality of disparate vehicle make and models with different subsystems and communications protocols. As such, the vehicle inventory controller may be integrated with the vehicle controller in a subset of the vehicle inventory fleet 104 and be separate from the vehicle controller in another subset of the vehicle inventory fleet 104.

The inventory management controller 102 may communicate with the user device 106 and/or one or more vehicles in the vehicle inventory fleet 104 via wireless connection such as WiFi, Bluetooth, satellite, cellular, and/or the like. For example, the inventory management controller 102 may connect with the user device 106 via one or more networks, such as a cellular, WiFi, satellite, or similar networks and with each of the vehicles in the vehicle inventory fleet via a local network, such as Bluetooth, WiFi, or similar networks. In some cases, the inventory management controller 102 is an application hosted in a network environment that is accessible using the user device 106. Thus, in some implementations, the user device 106 communicates directly with one or more of the vehicle inventory controllers in the vehicle inventory fleet 104, for example, through a Bluetooth connection, WiFi connection, and/or the like. It will be appreciated that the vehicle inventory management system 100 may include various components that may be separate, integrated, and/or the like and communicate in various manners to manage the vehicle inventory fleet 104. Additionally, it will be appreciated that inventory management commands, including a security command (e.g., to lock a vehicle) and an exhibit command (e.g., to unlock a vehicle), may be converted into vehicle specific commands unique to the various subsystems and communication protocols of each vehicle using one or more of the inventory management controller 102, the vehicle inventory controller, the vehicle controller, the user device 106, and/or the like.

In one implementation, the inventory management controller 102 provides an easy, central mechanism to lock and unlock an entirety of the vehicle inventory fleet 104 simultaneously. More particularly, a user may select an option to unlock or lock the entire vehicle inventory fleet 104 using the user device 106, which will send a command over a wireless network to each vehicle in the vehicle inventory fleet 104, which will then unlock or lock. For example, many insurance companies require the vehicle inventory fleet 104 be locked outside of business hours. Thus, a user can lock the entire vehicle inventory fleet 104 simultaneously at the end of business hours and unlock the entire vehicle inventory fleet 104 simultaneously at the beginning of business hours.

Further, in one implementation, the inventory management controller 102 may be used to schedule an unlock time at which the inventory management controller 102 automatically sends an exhibit command to each of the vehicles to unlock and a lock time at which the inventory management controller 102 automatically sends a security command to each of the vehicles to lock. In some implementations, a security threat to one or more of the vehicles may be detected and in response, the inventory management controller 102 automatically sends the security command to the entirety of the fleet 104 to lock. For example, if a break-in is detected at one of the vehicles using the antitheft technology of the vehicle, the vehicle inventory controller may send a communication regarding the threat to the inventory management controller 102, which then automatically sends the security command to the entirety of the fleet 104 to lock in response. Similarly, if a security system of the dealership detects a threat (e.g., a presence of a person on the property outside of business hours), the security system may communicate that threat to the inventory management controller 102 for action. The inventory management controller 102 may generate and send a security command to the vehicle inventory fleet 104 in response to one or more of such security triggering events, including a scheduled time of day, manual commands, detection of a security threat, and/or the like.

To show a vehicle to a customer, a user may access the inventory management controller 102 using the user device 106 to select a vehicle from the fleet 104. For example, the vehicle may be selected using a stock number, a VIN number, or some other identification particular to the vehicle. Upon selection, the inventory management controller 102 will isolate that vehicle from the fleet 104 or otherwise establish communication with the vehicle separate from the fleet 104 to send an exhibit command to unlock the vehicle for display. Unlocking the vehicle in this manner allows the customer to look at the vehicle while the sales personnel retrieves the key for a test drive. Further, a vehicle may be remotely unlocked to allow a customer to view an interior of the vehicle while the sales person is otherwise elsewhere and ensure the access to the vehicle by the customer is limited (e.g., the customer cannot drive the vehicle without the presence of a sales person). In some cases, the inventory management controller 102 may be used to grant authority to select sales personnel and/or third parties to access the vehicles in this manner and to track their activities in accessing the vehicles. The inventory management controller 102 may further be used to track a location of a vehicle (e.g., where it is parked, if it is out for a test drive, if it is in maintenance, its location if stolen, etc.), remotely disable an operation of a vehicle if it is stolen or being driven by an unauthorized driver, and in cases where the vehicle is autonomous or semiautonomous to fetch the vehicle to a current location. The inventory management controller 102 may further provide a list of available vehicles that may be categorized and filtered.

In one implementation, the inventory management controller 102 communicates with the vehicle inventory controller associated with each vehicle in the fleet 104 to capture onboard diagnostic data for the vehicle. The onboard diagnostic data may be correlated with a VIN number, stock number, or other vehicle identifier, such that the inventory management controller 102 parses the data collected for the entirety of the fleet 104 and generates alerts for a particular vehicle based on the data. The alerts may indicate various conditions of the vehicle that need attention or that a sales person should be aware of prior to attempting to take a customer for a test drive. For example, low fuel, dead battery, low tire pressure, check engine light, control failure, and/or the like. In some cases, the inventory management controller 102 may automatically or through user input select a technician or other personnel to address the alert. Here, the inventory management controller 102 may generate a workflow delegating responsibility for an alert, notifying the associated person of the task, and tracking the task to completion. Employee statistics for responding to and completing tasks in an efficient manner may further be generated to track employee performance. Further in some cases, the inventory management controller 102 may generate an order for one or more items automatically based on the alerts. For example, each make and model of vehicle may use a different battery type. The inventory management controller 102 may identify all alerts corresponding to a need for a new battery and automatically submit an order for the specific batteries needed.

Insurance carriers often include a provision in policies directed at the fleet 104 being secured outside of business hours, such that in submitting a claim regarding a theft, the insurance carrier will inquire whether the fleet 104 was locked at the time of the incidence in compliance with the policy. In one implementation, the inventory manager application 202 provides inventory management data for the dealership from which fleet locking status data for the fleet 104 during a specified time over a compliance period may be extracted. For example, the specified time may be when the policy dictates that the fleet 104 be locked and the compliance period may be at the time of a security threat for which a claim is made to determine whether a claim is valid in compliance with the policy. As another example, the specified time may be when the policy dictates that the fleet 104 be locked and the compliance period may be over a regularly occurring interval to determine whether the dealership is regularly complying with the policy. If the dealership is regularly complying with the policy, the carrier may provide incentive discounts and/or the like.

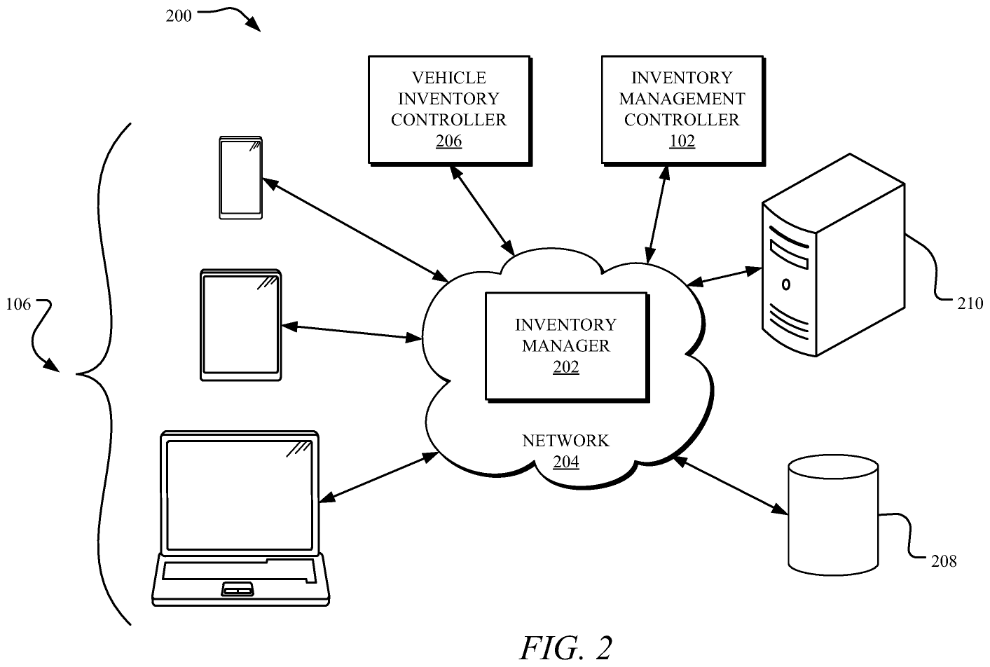

For a detailed description of an example network environment 200 for providing vehicle inventory management, reference is made to FIG. 2. In one implementation, a user, such as dealership personnel, accesses and interacts with an inventory manager application 202 using the user device 106 to access or provide vehicle inventory management via a network 204 (e.g., the Internet).

The user device 106 is generally any form of computing device capable of interacting with the network 204, such as a personal computer, terminal, workstation, portable computer, mobile device, smartphone, tablet, multimedia console, etc. The network 204 is used by one or more computing or data storage devices (e.g., a vehicle controllers 206, the inventory management controller 102, one or more databases 208 or other computing units described herein) for implementing the inventory manager application 202 and other services, applications, or modules in the network environment 200.

In one implementation, the network environment 200 includes at least one server 210 hosting a website or an application that the user may visit to access the inventory manager application 202 and/or other network components. The server 210 may be a single server, a plurality of servers with each such server being a physical server or a virtual machine, or a collection of both physical servers and virtual machines. In another implementation, a cloud hosts one or more components of the network environment 200. The user devices 106, the vehicle inventory controllers 206, the inventory management controller 102, the the server 210, and other resources connected to the network 204 may access one or more other servers to access to one or more websites, applications, web services interfaces, storage devices, computing devices, or the like that are used for vehicle inventory management. The server 210 may also host a search engine that the inventory manager application 202 uses for accessing, searching for, executing, and modifying inventory management commands, onboard diagnostics data, inventory management data, fleet locking status data, alerts, workflows, orders, claims, and other data, as described herein.

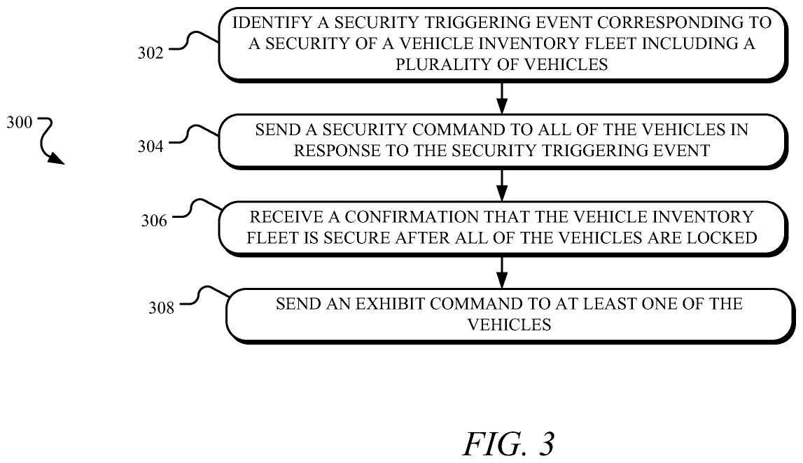

FIG. 3 illustrates example operations 300 for vehicle inventory management. In one implementation, an operation 302 identifies a security triggering event corresponding to a security of a vehicle inventory fleet. The vehicle inventory fleet includes a plurality of vehicles. The security triggering event may include a time matching a predetermined time, a manual command input with a user device, a detection of a security threat to one or more of the plurality of vehicles, and/or the like. Where the security triggering event includes the time matching the predetermined time, the security command may be automatically sent at the predetermined time. Where the security triggering event includes the manual command input with the user device the manual command may be input using a touch screen, a microphone, a camera, and/or an input device. For example, the manual command may be a verbal command, a visual command, such as a gesture, input using a graphical user interface presented with a user device, and/or the like.

An operation 304 sends a security command to all of the plurality of vehicles over a network in response to the security triggering event, the security command causing all of the plurality of vehicles to lock. In one implementation, the security command is received at a vehicle inventory controller of a corresponding vehicle of the plurality of vehicles. The vehicle inventory controller triggers locking operations specific to the corresponding vehicle upon receiving the security command. For example, the locking operations may be specific to a make and model of the particular vehicle, a locking subsystem of the particular vehicle (e.g., mechanical locking subsystem, electronic locking subsystem, a keyless entry locking subsystem, etc.). The vehicle inventory controller may be a separate, removable component deployed into the corresponding vehicle, integrated with a vehicle controller of the corresponding vehicle, and/or the like.

An operation 306 receives a confirmation that the vehicle inventory fleet is secure after all of the plurality of vehicles are locked, and an operation 308 sends an exhibit command to at least one of the plurality of vehicles over the network. The exhibit command causes the at least one of the plurality of vehicles to unlock.

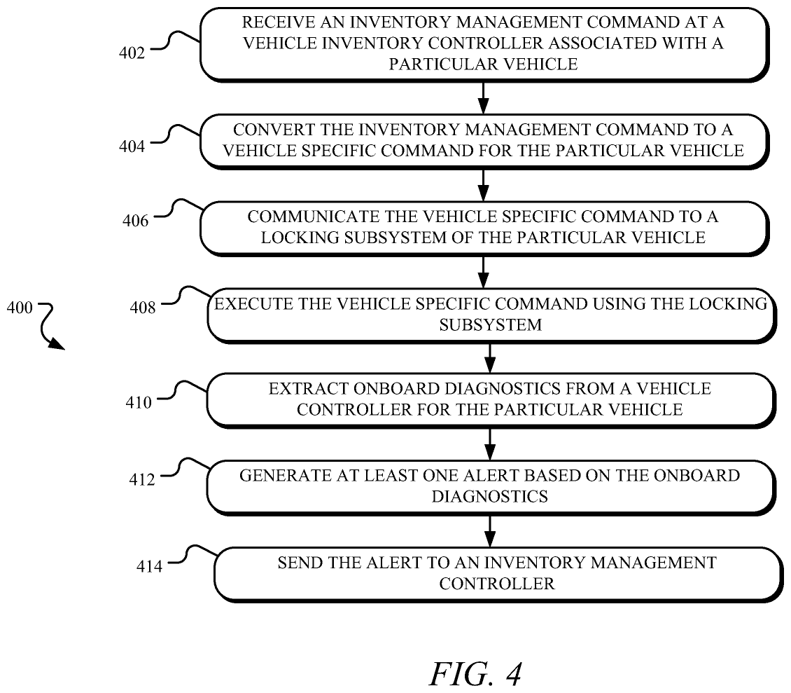

Turning to FIG. 4, example operations 400 for managing a vehicle in a vehicle inventory fleet. In one implementation, an operation 402 receives an inventory management command at a vehicle inventory controller associated with a particular vehicle. The inventory management command is sent in response to an inventory triggering event for a vehicle inventory subset, where the vehicle inventory subset including one or more vehicles, including the particular vehicle selected from a vehicle inventory fleet. The inventory management command includes a locking command or an unlocking command. In one implementation, the inventory management command is sent automatically in response to an automatic identification of the inventory triggering event.

An operation 404 converts the inventory management command to a vehicle specific command for the particular vehicle using the vehicle inventory controller. An operation 406 communicates the vehicle specific command to a locking subsystem of the particular vehicle. The locking subsystem includes at least one of a mechanical lock, an electronic lock, a keyless entry lock, and/or the like. An operation 408 executes the vehicle specific command using the locking subsystem to unlock or lock the particular vehicle.

In one implementation, an operation 410 extracts onboard diagnostics from a vehicle controller for the particular vehicle. The vehicle specific controller may be integrated with the vehicle controller. Alternatively, the vehicle specific controller may be separate and removable from the particular vehicle and communicate with the vehicle controller. An operation 412 generates at least one alert based on the onboard diagnostics using the vehicle inventory controller, and an operation 414 sends the alert to an inventory management controller over a network. In one implementation, the inventory management controller generates an alert list including a plurality of alerts for the vehicle inventory fleet, which includes the alert for the particular vehicle. The plurality of alerts may be arranged in the alert list by a priority, a receipt time, and/or an alert type. The priority may be assigned based on preset categories, an urgency of the alert, the vehicle type, vehicle status, and/or the like.

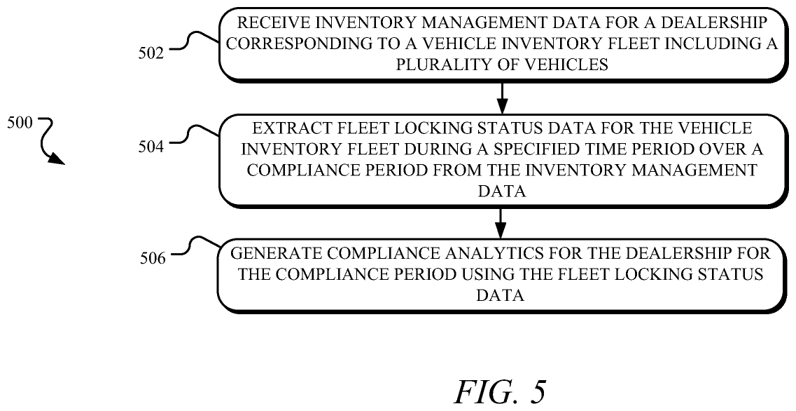

FIG. 5 depicts example operations 500 for vehicle inventory management compliance. In one implementation, an operation 502 receives inventory management data for a dealership from an inventory management controller. The inventory management data corresponds to a vehicle inventory fleet including a plurality of vehicles. An operation 504 extracts fleet locking status data for the vehicle inventory fleet during a specified time period over a compliance period from the inventory management data. The specified time period may be outside business hours, correspond to a contractual time period in an insurance policy, and/or the like. An operation 506 generates compliance analytics for the dealership for the compliance period using the fleet locking status data. The compliance analytics may include determining a locking status of a selected vehicle from the vehicle inventory fleet during the specified time period over the compliance period; a compliance percentage of the dealership in locking the vehicle inventory fleet during the specified time period over the compliance period; and/or the like. The compliance period may be a specific time window corresponding to an event, a regularly occurring period, and/or the like.

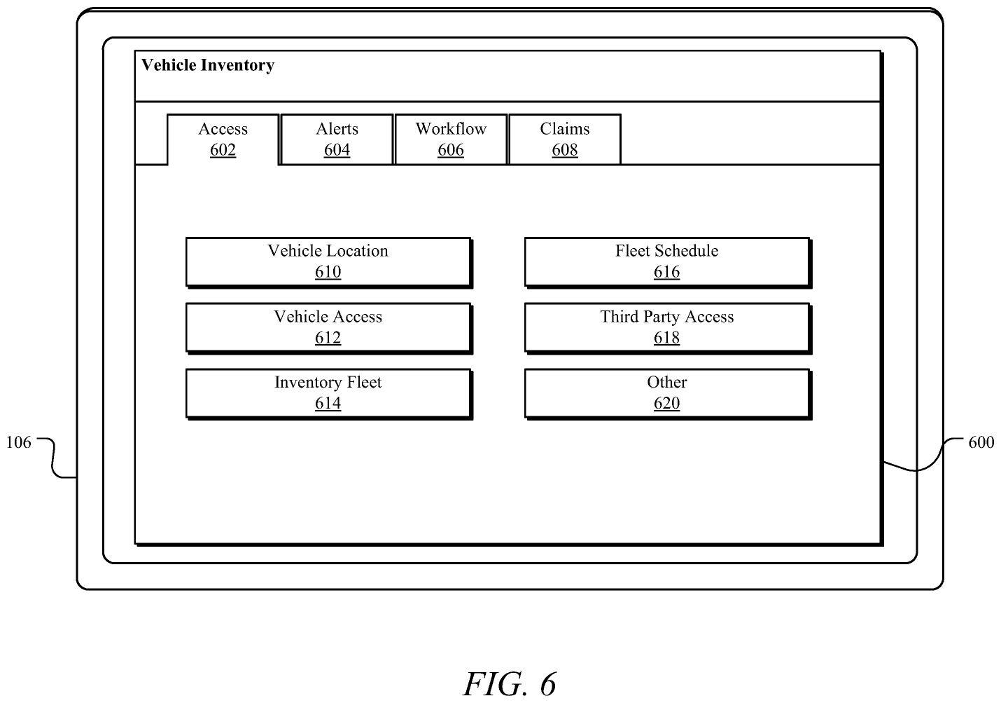

FIG. 6 shows an example vehicle inventory management user interface 600 generated by a computing device and displayed in a window of a user device, such as the user device 106, or other vehicle inventory management interface through which access to and interactions with the inventory management systems and methods described herein and related data are provided. It will be appreciated by those skilled in the art that such depictions are exemplary only and not intended to be limiting.

In one implementation, vehicle inventory management user interface 600 may include one or more navigation tabs (e.g., tabs 602-608) to navigate among various services, data, or options for managing the fleet 104. For example, an access tab 602 may control access to the fleet 104; an alerts tab 604 may provide access to alerts and onboard diagnostic data for the fleet 104; a workflow tab 606 may provide access to one or more workflows regarding maintenance or other tasks associated with management of the fleet 104, including who is responsible for the tasks and a status of the task; and a claims tab 608 may provide access to information regarding any claims submitted for one or more vehicles in the fleet 104 for example regarding theft or damage. The access tab 602 may include a vehicle location option 610 to determine a location of each of the vehicles in the fleet 104 or to identify which vehicles are available; a vehicle access option 612 to lock or unlock one or more vehicles in the fleet 104; an inventory fleet option 614 to obtain analytics, data, and/or the like for the entirety of the fleet 104 and to issue inventory management commands to the fleet 104 simultaneously; a fleet schedule option 616 to schedule automatic delivery of inventory management commands to the fleet 104 (e.g., unlocking and locking the fleet 104 at specific times; a third party access option 618 to export or authorize access to data for a third party, such as a carrier, partner, or to place an order; and an other option 620 for inputting custom options or accessing additional options for managing the fleet 104.

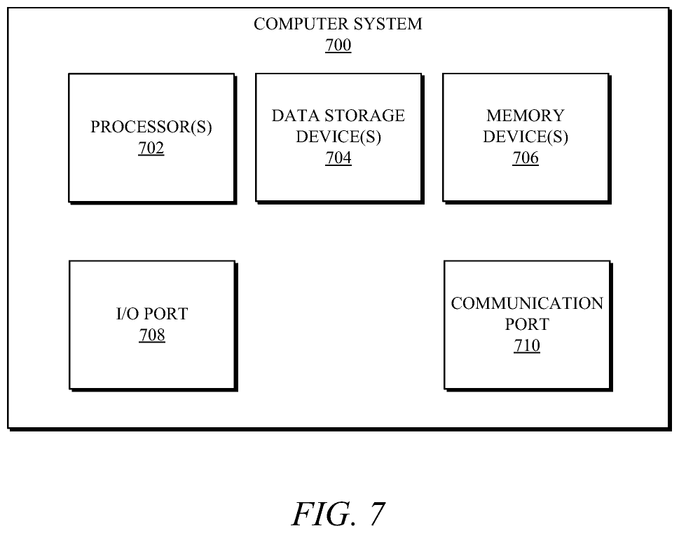

Referring to FIG. 7, a detailed description of an example computing system 700 having one or more computing units that may implement various systems and methods discussed herein is provided. The computing system 700 may be applicable to the inventory management controller 102, the inventory manager 202, the vehicle inventory controller 206, and other computing or network devices. It will be appreciated that specific implementations of these devices may be of differing possible specific computing architectures not all of which are specifically discussed herein but will be understood by those of ordinary skill in the art.

The computer system 700 may be a computing system is capable of executing a computer program product to execute a computer process. Data and program files may be input to the computer system 700, which reads the files and executes the programs therein. Some of the elements of the computer system 700 are shown in FIG. 7, including one or more hardware processors 702, one or more data storage devices 704, one or more memory devices 708, and/or one or more ports 708-710. Additionally, other elements that will be recognized by those skilled in the art may be included in the computing system 700 but are not explicitly depicted in FIG. 7 or discussed further herein. Various elements of the computer system 700 may communicate with one another by way of one or more communication buses, point-to-point communication paths, or other communication means not explicitly depicted in FIG. 7.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The computer system 700 may be a conventional computer, a distributed computer, or any other type of computer, such as one or more external computers made available via a cloud computing architecture. The presently described technology is optionally implemented in software stored on the data stored device(s) 704, stored on the memory device(s) 706, and/or communicated via one or more of the ports 708-710, thereby transforming the computer system 700 in FIG. 7 to a special purpose machine for implementing the operations described herein. Examples of the computer system 700 include personal computers, terminals, workstations, mobile phones, tablets, laptops, personal computers, multimedia consoles, gaming consoles, set top boxes, and the like.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 700 includes one or more ports, such as an input/output (I/O) port 708 and a communication port 710, for communicating with other computing, network, or vehicle devices. It will be appreciated that the ports 708-710 may be combined or separate and that more or fewer ports may be included in the computer system 700.

The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. Similarly, the output devices may convert electrical signals received from computing system 700 via the I/O port 708 into signals that may be sensed as output by a human, such as sound, light, and/or touch. The input device may be an alphanumeric input device, including alphanumeric and other keys for communicating information and/or command selections to the processor 702 via the I/O port 708. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 700 via the I/O port 708. For example, an electrical signal generated within the computing system 700 may be converted to another type of signal, and/or vice-versa. In one implementation, the environment transducer devices sense characteristics or aspects of an environment local to or remote from the computing device 700, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 700, such as, physical movement of some object (e.g., a mechanical actuator), heating or cooling of a substance, adding a chemical substance, and/or the like.

In one implementation, a communication port 710 is connected to a network by way of which the computer system 700 may receive network data useful in executing the methods and systems set out herein as well as transmitting information and network configuration changes determined thereby. Stated differently, the communication port 710 connects the computer system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 710 to communicate one or more other machines, either directly over a point-to-point communication path, over a wide area network (WAN) (e.g., the Internet), over a local area network (LAN), over a cellular (e.g., third generation (3G), fourth generation (4G), or fifth generation (5G)) network, or over another communication means. Further, the communication port 710 may communicate with an antenna or other link for electromagnetic signal transmission and/or reception.

In an example implementation, inventory management data, fleet locking status data, compliance analytics, vehicle inventory management operations, and software and other modules and services may be embodied by instructions stored on the data storage devices 704 and/or the memory devices 706 and executed by the processor 702. The computer system 700 may be integrated with or otherwise form part of various components of the network environment 200.

The system set forth in FIG. 7 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for vehicle inventory management, the method comprising:
identifying a security triggering event corresponding to a security of a vehicle inventory fleet, the vehicle inventory fleet including a plurality of vehicles;
sending a security command to all of the plurality of vehicles over a network in response to the security triggering event, the security command causing all of the plurality of vehicles to lock; and
receiving a confirmation that the vehicle inventory fleet is secure after all of the plurality of vehicles are locked.

2. The method of claim 1, wherein the security triggering event includes a time matching a predetermined time.

3. The method of claim 2, wherein the security command is automatically sent at the predetermined time.

4. The method of claim 1, wherein the security triggering event is a manual command input with a user device.

5. The method of claim 4, wherein the manual command is input using at least one of a touch screen, a microphone, a camera, or an input device.

6. The method of claim 1, wherein the security triggering event includes a detection of a security threat to one or more of the plurality of vehicles.

7. The method of claim 1, wherein the security command is received at a vehicle inventory controller of a corresponding vehicle of the plurality of vehicles, the vehicle inventory controller triggering locking operations specific to the corresponding vehicle upon receiving the security command.

8. The method of claim 7, wherein the vehicle inventory controller is a separate, removable component deployed into the corresponding vehicle or the vehicle inventory controller is integrated with a vehicle controller of the corresponding vehicle.

9. The method of claim 1, further comprising:
sending an exhibit command to at least one of the plurality of vehicles over the network, the exhibit command causing the at least one of the plurality of vehicles to unlock.

10. A method for vehicle inventory management, the method comprising:
receiving an inventory management command at a vehicle inventory controller associated with a particular vehicle, the inventory management command sent in response to an inventory triggering event for a vehicle inventory subset, the vehicle inventory subset including one or more vehicles selected from a vehicle inventory fleet, the vehicle inventory subset including the particular vehicle, the inventory management command including one of a locking command or an unlocking command;
converting the inventory management command to a vehicle specific command for the particular vehicle using the vehicle inventory controller;
communicating the vehicle specific command to a locking subsystem of the particular vehicle; and
executing the vehicle specific command using the locking subsystem to unlock or lock the particular vehicle.

11. The method of claim 10, wherein the inventory management command is sent automatically in response to an automatic identification of the inventory triggering event.

12. The method of claim 10, wherein the locking subsystem includes at least one of a mechanical lock, an electronic lock, or a keyless entry lock.

13. The method of claim 10, further comprising:
extracting onboard diagnostics from a vehicle controller for the particular vehicle;
generating at least one alert based on the onboard diagnostics using the vehicle inventory controller; and
sending the at least one alert to an inventory management controller over a network.

14. The method of claim 13, wherein the inventory management controller generates an alert list including a plurality of alerts for the vehicle inventory fleet, the alert list including the alert for the particular vehicle.

15. The method of claim 14, wherein the plurality of alerts is arranged in the alert list by at least one of a priority, a receipt time, or an alert type.

16. A method for vehicle inventory management compliance, the method comprising:
receiving inventory management data for a dealership from an inventory management controller, the inventory management data corresponding to a vehicle inventory fleet including a plurality of vehicles;
extracting fleet locking status data for the vehicle inventory fleet during a specified time period over a compliance period from the inventory management data; and
generating compliance analytics for the dealership for the compliance period using the fleet locking status data.

17. The method of claim 16, wherein the compliance analytics includes determining a locking status of a selected vehicle from the vehicle inventory fleet during the specified time period over the compliance period.

18. The method of claim 16, wherein the compliance analytics includes a compliance percentage of the dealership in locking the vehicle inventory fleet during the specified time period over the compliance period.

19. The method of claim 16, wherein the specified time period is outside business hours.

20. The method of claim 16, wherein the compliance period is a specific time window corresponding to an event or a regularly occurring period.
